(19) United States
(12) Patent Application Publication
(10) Pub. No.: US 2009/0297319 A1
(43) Pub. Date: Dec. 3, 2009

(54) COMPOSITE FOR AUTOMATED HANDLING DEVICE

(76) Inventors: James R. Kalb, Petersburg, MI (US); Michael Thomas Charlton, Clinton, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/471,536

(22) Filed: May 26, 2009

Related U.S. Application Data
(60) Provisional application No. 61/057,887, filed on Jun. 2, 2008.
(60) Provisional application No. 61/108,881, filed on Oct. 28, 2008.

(51) Int. Cl. B65G 1/133; B29C 67/00; B29C 49/26

(52) U.S. Cl. 414/751.1; 264/241; 264/516; 901/31; 901/40

(57) ABSTRACT

A composite support arm for an automated handling device includes an elongated tubular body having an outer metal layer and an inner fibrous reinforcement layer adjacent to the outer metal layer.

### RELATED APPLICATIONS

This application claims priority to U.S. Provisional Application Nos. 61/057,887, filed Jun. 2, 2008, and 61/108,881, filed Oct. 28, 2008.

### BACKGROUND OF THE INVENTION

This disclosure generally relates to strong and lightweight composite tubes.

Tubing is used in a wide variety of different applications. As an example, automated handling equipment may be used in an industrial setting for transferring work pieces between work stations. Typically the equipment includes tools that attach onto the work pieces to move the work pieces between work stations. The tools may be clamped onto support tubes that are secured to a robotic machine for moving the tools between the work stations. Conventional support tubes are high-strength steel tubes for supporting the weight of the tools and the work pieces.

### SUMMARY OF THE INVENTION

An exemplary composite support arm for an automated handling device includes an elongated tubular body having an outer metal layer and an inner fibrous reinforcement layer adjacent to the outer metal layer.

An exemplary method of forming the composite support arm includes forming the elongated tubular body with the outer metal layer adjacent to the inner fibrous reinforcement layer.

In embodiments, the support arm may be within an automated handling device that includes at least one tool for handing a work piece and a robotic machine for moving the tool. One or more of the support arms may be connected between the tool or tools and the robotic machine.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 illustrates an example automated handling device.

FIG. 2 illustrates a radial cross-section of an example support arm.

FIG. 3 illustrates an axial cross-section of the support arm.

FIG. 4 illustrates the support arm and an example clamp in an unassembled position.

FIG. 5 illustrates the support arm and the clamp in an assembled position.

FIG. 6 illustrates another example support arm for use in the automated handling device.

FIG. 7 illustrates a radial cross-section of another example support arm.

FIG. 8 illustrates an example composite support arm in one step of a processing method for fabricating the support arm.

FIG. 9 illustrates an example composite support arm at another step of a processing method for fabricating the support arm.

FIG. 10 illustrates a radial cross-section of another example support arm having an anti-friction layer.

FIG. 11 illustrates a radial cross-section of another example support arm.

### DETAILED DESCRIPTION OF THE PREFERRED EMBODIMENT

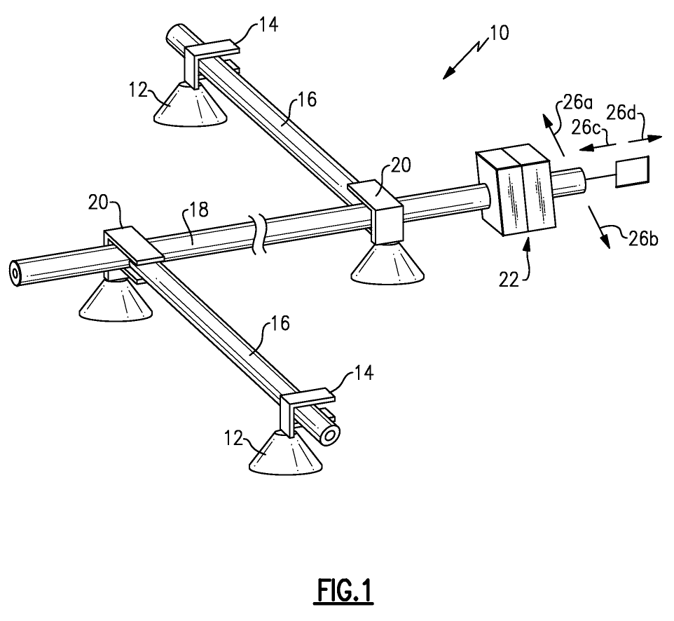

FIG. 1 illustrates selected portions of an example automated handling device 10. The automated handling device 10 may be used in a variety of different configurations and settings from that shown. In the illustrated example, the automated handling device 10 includes a plurality of tools 12 for moving work pieces, such as sheets, partially formed or fully formed parts, between work stations.

The tools 12 of the illustrated example are shown as suction cups; however, some or all of the tools 12 may alternatively be powered grippers (e.g., pneumatic, motorized, etc.), powered clamps (e.g., pneumatic, motorized, etc.), or other types of powered tools. Clamps 14 (shown generically) secure each of the tools 12 to support arms 16 that extend from a rail arm 18. Clamps 20 (shown generically) secure the support arms 16 to the rail arm 18. The rail arm 18 is secured at one end to an adaptor/receiver device 22 that connects the collective assembly of the tools 12, support arms 16, and rail arm 18 to an automated device 24, such as a robotic machine. The automated device 24 may move the tools 12 in any of the illustrated directions 26a-26d, for example.

As may be appreciated, the clamps 14/20 are adjustable such that the position of the clamps 14 and/or 20 relative to the support arms 16 and the rail arm 18 may be changed to accommodate different work pieces. The clamps 14 and/or 20 may be loosened and retightened on the support arms 16 and rail arm 18, depending upon the desired position of the tools 12. The disclosed support arms 16 and rail arm 18 are lightweight, strong (for supporting the tools 12), and durable (to withstand the wear and tear from repeated clamping cycles).

The support arms 16, the rail arm 18, or both are formed from a strong, lightweight, and durable composite. FIG. 2 illustrates a radial cross-section of one of the support arms 16, and FIG. 3 illustrates an axial cross-section of one of the support arms 16. As can be appreciated, the examples illustrated in FIGS. 2 and 3 may also be applied to the rail arm 18, which may also have a different cross-sectional profile than the cylindrical profile shown. The support arm 16 includes an outer metal layer 30 and an inner fibrous reinforcement layer 32 adjacent to the outer metal layer 30. For instance, the outer metal layer 30 provides the durability to repeated clamping and the inner fibrous reinforcement layer 32 provides strength and is lightweight. In this example, the interior of the support arm 16 is hollow.

The metal used for the outer metal layer 30 may be any type of metal that is suitable for the intended use of the support arm 16. In one example, the metal is aluminum, aluminum alloy, or steel, but may alternatively be another type of metal or metal alloy that is desired for a particular intended end use. The thickness of the outer metal layer 30 may vary depending on the desired intended end use but in some examples may be between about 10 micrometers and 10 millimeters thick. In some examples, the thickness may be about 1-3 millimeters.

The material of the inner fibrous reinforcement layer 32 may be any type of fibrous material that is suitable for providing reinforcement. As an example, the terms “fibrous” and “fiber” may refer to elongated filaments that are generally cylindrical. The fibrous material may be a polymer/fiber composite that includes fibers 34 distributed within a matrix 36. Alternatively, the inner fibrous reinforcement layer 32 may be “dry” (i.e., no resin) fibers 34 that are woven into a sleeve or sheet that is bonded to the interior wall of the outer metal layer 30. In either case, the fibers 34 may be wound, braided, woven, oriented or arranged in other desired orientations. The fibers 34 may also be continuous fibers or short fibers (distributed in the matrix 36).

The fibers 34 may be carbon fibers, glass fibers, polymeric fibers, or other types of fibers. The matrix 36 may be a thermoplastic material or a thermoset material. In one example, the matrix 36 is epoxy and the fibers 34 are carbon fibers.

FIG. 4 illustrates one of the support arms 16 and one of the clamps 14 for tightening around the support arm 16 to support one of the tools 12. The clamp 14 includes a first clamp section 40 and a second clamp section 42 that are secured together using fasteners 44a and 44b. For example, each of the first clamp section 40 and the second clamp section 42 includes openings 46 for receiving the respective fastener 44a or 44b.

Each of the first clamp section 40 and the second clamp section 42 includes respective clamping surfaces 48a and 48b that in this case directly contact the radially outer surface of the outer metal layer 30 of the support arm 16. For example, the clamping surfaces 48a and 48b may be textured, knurled, or roughened to facilitate clamping of the support arm 16 and limiting rotation about centerline axis A when the fasteners 44a and 44b are tightened, as illustrated in FIG. 5. Thus, the outer metal layer 30 may be subjected to a relatively high clamping force from the clamping surfaces 48a and 48b. In this regard, the outer metal layer 30 provides durability and resists significant indentation or material loss from contact with the clamping surfaces 48a and 48b. For example, a support arm with exposed polymer composite may be heavily worn, indented, eroded, or scraped by the clamping surfaces, which may result in failure or necessitate replacement.

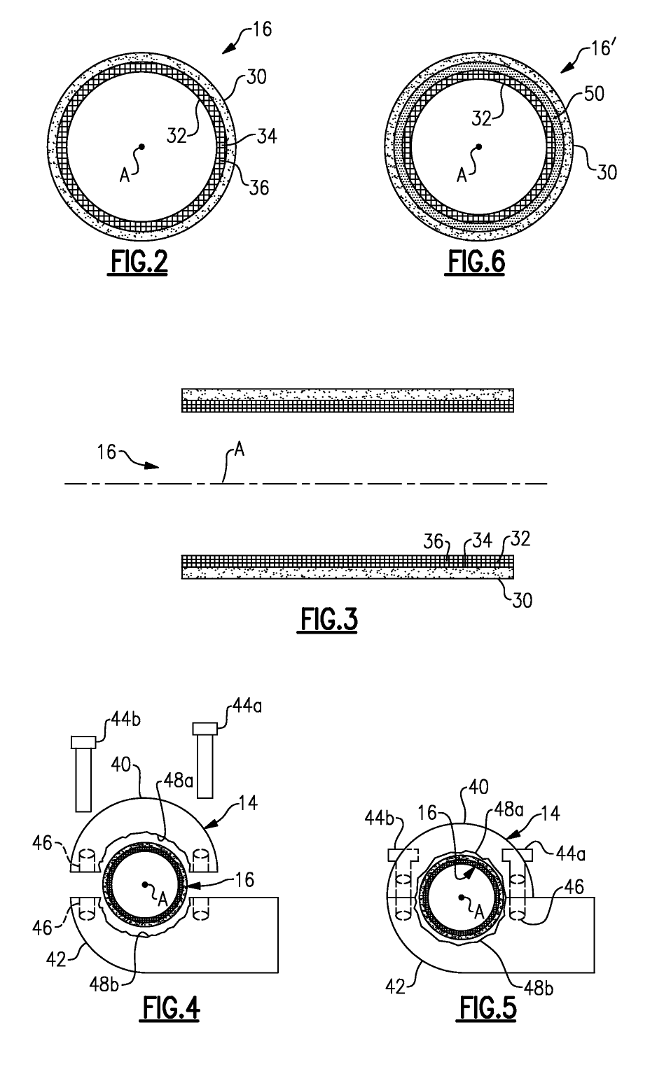

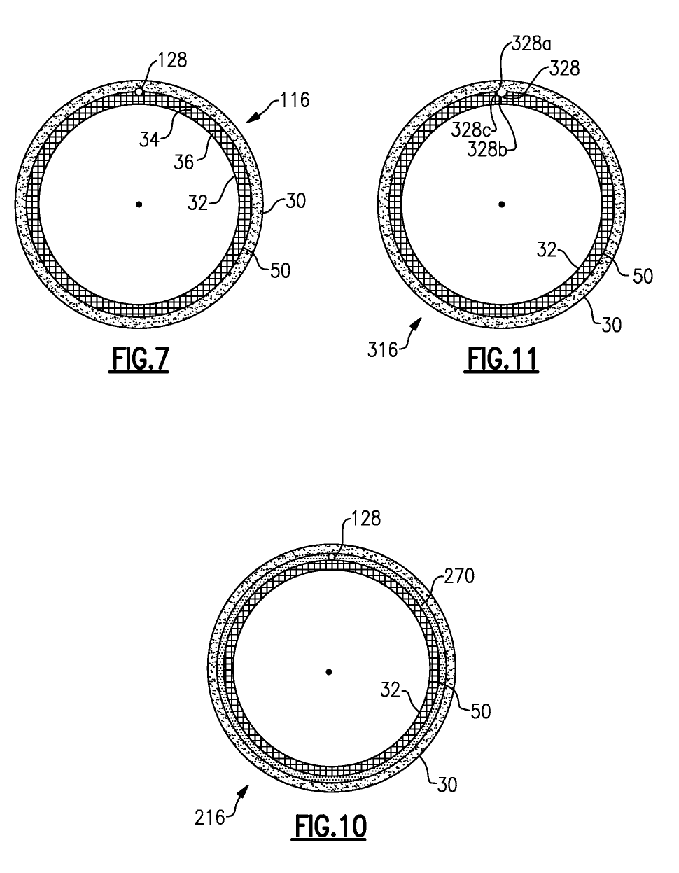

FIG. 6 illustrates another example support arm 16′ that may be used in the automated handling device 10 in place of the previous example support arm 16. The support arm 16′ includes the outer metal layer 30 and the inner fibrous reinforcement layer 32. However, the support arm 16′ additionally includes an intermediate bonding layer 50 that secures the inner fibrous reinforcement layer 32 to the outer metal layer 30. The bonding layer 50 provides the benefit of strongly securing the inner fibrous reinforcement layer 32 to the outer metal layer 30 to resist delamination over the lifetime of the support arm 16′.

The bonding layer 50 may be an adhesive material that bonds with the metal of the outer metal layer 30 and the composite material of the inner fibrous reinforcement layer 32. In a few examples, the adhesive material of the bonding layer 30 is a polymer. The polymer may be the same type of polymer as the matrix 36 of the inner fibrous reinforcement layer 32. For instance, the polymer of the bonding layer 50 may be epoxy.

The inner surface of the outer metal layer 30 may be treated to promote a strong bond with the bonding layer 50. For instance, the inner surface may be cleaned with a cleaning agent, such as a solvent (e.g., acetone). Alternatively or in addition to cleaning the inner surface, the inner surface may be treated in any other desirable manner to promote bonding.

The support arms 16 and 16′ may be formed using known molding techniques. In one example, a preform of the inner fibrous reinforcement layer 32 is inserted into the tubular shape of the outer metal layer 30. For instance, the preform may have a diameter that is smaller than the diameter of the outer metal layer 30. The preform may be a dry sleeve with the fibers 34 or a prepreg of the fibers 34 and uncured resin matrix 36. The preform is deformable such that an internal pressure may be applied to push the preform outwards against the radially inner side of the outer metal layer 30. After pressurization, the support arm 16 or 16′ may be heated to cure the bonding layer 50 and/or preform and thereby form the inner fibrous reinforcement layer 32.

The preform may be heated in unison with pressurizing, to cure the bonding layer 50 and/or uncured resin matrix 36. For the support arm 16′, the outside of the preform may be coated prior to pressurization with the adhesive material that forms the bonding layer 50. In other examples, the inner fibrous reinforcement layer 32 may be formed as a tubular structure, and the outer metal layer may be subsequently applied to the outside of the inner fibrous reinforcement layer 32 using known coating techniques, such as spray deposition.

FIG. 7 illustrates another support arm 116 that is similar to the support arm 16. In this disclosure, like reference numerals designate like elements where appropriate, and reference numerals with the addition of one-hundred or multiples thereof designate modified elements. The modified elements may incorporate the same features and benefits of the corresponding original elements and vice-versa. In this case, the support arm 116 includes at least one rib 128 that facilitates manufacturing the support arm 116 and remains as an artifact within the structure of the support arm 116 after processing. In one example, the rib 128 is a metal wire. In the illustrated example, there is only one rib 128. Additional ribs 128 may be used, however, too many ribs that are close together may hinder continuous bonding between the bonding layer 50 and the outer metal layer 30. The rib 128 may also serve to strengthen or reinforce the support arm 116.

FIG. 8 illustrates the support arm 116 in an incomplete state during a manufacturing step. The outer metal layer 30 and inner fibrous reinforcement layer 32 are generally hollow and include an internal cavity 131. In this case, the internal cavity 131 includes an inflatable bladder 160, such as a rubber bladder. The inflatable bladder 160 may include fittings (not shown) on each end for sealing the bladder 160 and/or connecting the bladder 160 to a pressurized fluid source.

The inner fibrous reinforcement layer 32 is arranged around the bladder 160 and inserted into the outer metal layer 30 such that there is a gap between the outer metal layer 30 and the outer surface of the inner fibrous reinforcement layer 32. The inflatable bladder 160 is then inflated to expand the inner fibrous reinforcement layer 32 toward the outer metal layer 30. The bladder 160 expands the inner fibrous reinforcement layer 32 and the bonding layer 50 against the inside wall of the outer metal layer 30.

The rib 128 facilitates forming a strong, continuous bond between the inner fibrous reinforcement layer 32 and outer metal layer 30. In this case, the rib 128 extends in a lengthwise direction between the inner fibrous reinforcement layer 32 and the outer metal layer 30 to provide a path for discharging the air. In one example, the rib 128 extends in a lengthwise direction that is parallel to a central axis A of the support arm 116.

The rib 128 may be attached (e.g., using adhesive) to the interior of the inner fibrous reinforcement layer 32 prior to inflating the bladder 160 to hold the rib 128 in a desired position. A bubble may form if air remains between the inner fibrous reinforcement layer 32 and the outer metal layer 30 when the bladder 160 is pressurized, which could prevent local bonding in the region of the bubble. For instance, the pressure exerted by the bladder 160 may push any air bubbles toward the rib 128. The bonding layer 50 and inner fibrous reinforcement layer 32 may not, at least initially, physically conform to the shape of the rib 128 such that there is a path that allows the air from any air bubbles to escape from between the inner fibrous reinforcement layer 32 and the outer metal layer 30 before curing of the bonding layer 50. With more time and/or the application of heat, the bonding layer 50 and the inner fibrous reinforcement layer 32 may later fully conform to the profile of the rib 128.

In some examples, the bladder 160 may be pressurized under an elevated temperature to soften the inner fibrous reinforcement layer 32 and bonding layer 50 for expansion against the outer metal layer 30. The elevated temperature may also cure the bonding layer 50 as pressure is applied. In other examples, the bonding layer 50 may cure over time without application of heat. Upon curing, the pressure within the bladder 160 may be released and the bonding layer 50 bonds the inner fibrous reinforcement layer 32 and the outer metal layer 30 together.

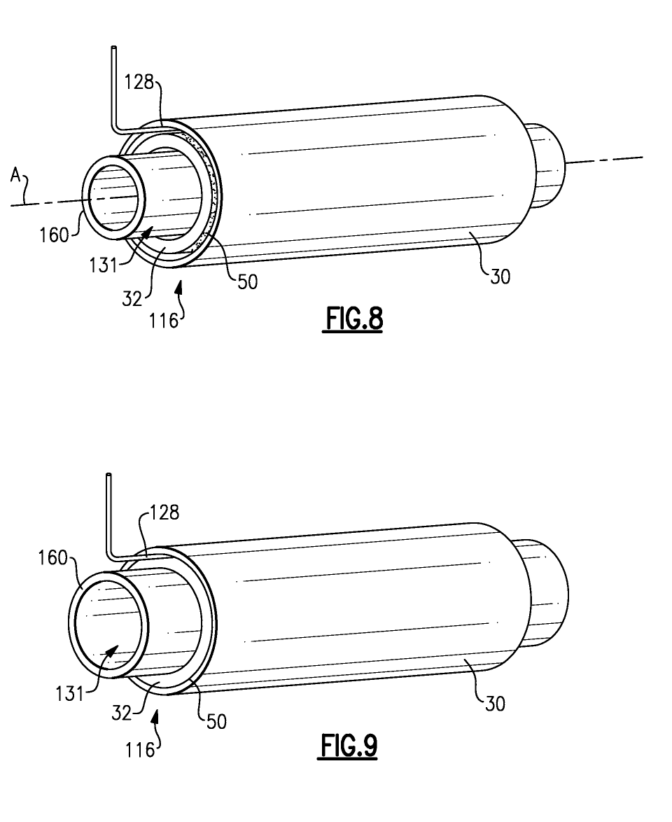

The end of the rib 128 may extend from the support arm 116 and may be removed; however, a length of the rib 128 may remain in the support arm 116. Using the rib 128 to remove air bubbles from the support arm 116 during the processing method facilitates forming a continuous strong bond between the inner fibrous reinforcement layer 32 and the radially outer metal layer 30. FIG. 9 illustrates a view of the support arm 116 after the pressurization of the bladder 160.

FIG. 10 illustrates another example support arm 216 that is somewhat similar to the support arm 116. The support arm 216 additionally includes an anti-friction layer 270 between the outer metal layer 30 and the inner fibrous reinforcement layer 32. The anti-friction layer 270 may include a fiber-glass layer or a porous plastic film, such as a polyester film (e.g., MYLAR®) having pores or openings for adhesive flow-through. The anti-friction layer 270 facilitates uniform distribution of the inner fibrous reinforcement layer 32 during the manufacturing process. For instance, if the inner fibrous reinforcement layer 32 includes fibers 34 that are dry, the fibers 34 slide relatively easily along the surface of the anti-friction layer 270 when the bladder 160 is inflated such that friction between the inner fibrous reinforcement layer 32 and the outer metal layer 30 does not prevent the fibers 34 from uniformly expanding into a desired orientation.

The anti-friction layer 270 may initially be in the form of a sheet that is rolled around the bladder 160, inner fibrous reinforcement layer 32, and bonding layer 50. The bladder 160, inner fibrous reinforcement layer 32, bonding layer 50, and anti-friction layer 270 may then be inserted into the outer metal layer 30. When the bladder 160 inflates, the adhesive of the bonding layer 50 flows through the anti-friction layer 270 to contact the outer metal layer 30 to form a continuous bond. For instance, the anti-friction layer 270 may be a fiber-glass cloth, where the adhesive flows between the fibers of the cloth.

FIG. 11 illustrates another example support arm 316 that is somewhat similar to the support arm 116. In this example, the support arm 316 includes an integral rib 328 that is formed with the outer metal layer 30. The integral rib 328 may be any desired shape. In the illustrated example, the integral rib 328 includes a base 328a at the inner surface of the outer metal layer 30, a free end 328b, and a pair of sloped side walls 328c that extend between the base 328a and the free end 328b. In this case, the sloped side walls 328c converge toward the free end 328b such that the angle between the sloped side walls 328c and the inner surface of the outer metal layer 30 at the base 328a is greater than 90°.

The outer metal layer 30 may be extruded to form the rib 328 protruding from the inside surface. In this regard, the integral rib 328 eliminates the need for inserting and/or cutting the rib 128 of the previous examples. Similar to the rib 128, the bonding layer 50 and inner fibrous reinforcement layer 32 may not, at least initially, perfectly conform to the profile of the integral rib 328 during the manufacturing process and thereby allow air to discharge through the gap at the integral rib 328. The profile of the integral rib 328 with the sloped side walls 328c facilitates initially forming the path for air escape and ultimately later conforming much or all of the bonding layer 50 and inner fibrous reinforcement layer 32 with the surfaces of the rib 328.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure may be determined by studying the following claims.

What is claimed is:

1. A composite support arm for an automated handling device, comprising:
an elongated tubular body including an outer metal layer and an inner fibrous reinforcement layer adjacent to the outer metal layer.

2. The composite support arm as recited in claim 1, wherein the outer metal layer is selected from a group consisting of aluminum, steel, and combinations thereof.

3. The composite support arm as recited in claim 1, wherein the inner fibrous reinforcement layer includes reinforcement fibers distributed in a polymer matrix.

4. The composite support arm as recited in claim 3, wherein the polymer matrix is a thermoplastic material.

5. The composite support arm as recited in claim 3, wherein a polymer matrix is a thermoset material.

6. The composite support arm as recited in claim 3, wherein the polymer matrix is epoxy.

7. The composite support arm as recited in claim 3, wherein the fibers are braided or wound.

8. The composite support arm as recited in claim 1, further comprising a bonding layer between the outer metal layer and the inner fibrous reinforcement layer.

9. The composite support arm as recited in claim 8, wherein the bonding layer comprises an unfilled epoxy material and the inner fibrous reinforcement layer includes reinforcement fibers distributed in a polymer matrix of epoxy.

10. The composite support arm as recited in claim 1, further comprising a rib between the outer metal layer and the inner fibrous reinforcement layer.

11. The composite support arm as recited in claim 10, wherein the rib extends in a lengthwise direction that is parallel to a central axis of the elongated tubular body.

12. The composite support arm as recited in claim 10, wherein the rib is a metal wire.

13. The composite support arm as recited in claim 1, wherein the elongated tubular body is a cylindrical tube having a hollow interior.

14. The composite support arm as recited in claim 1, further comprising an anti-friction layer between the outer metal layer and the inner fibrous reinforcement layer.

15. The composite support arm as recited in claim 14, wherein the anti-friction layer comprises a porous polymer film.

16. The composite support arm as recited in claim 15, wherein the porous polymer film comprises a polyester material.

17. A method of forming a composite support arm for an automated handling device, the composite support arm including an elongated tubular body having an outer metal layer and an inner fibrous reinforcement layer adjacent to the outer metal layer, the method comprising:
forming the elongated tubular body with the outer metal layer adjacent to the inner fibrous reinforcement layer.

18. The method as recited in claim 17, wherein the forming of the elongated tubular body includes expanding an uncured preform inside of the outer metal layer against an inside wall of the outer metal layer, and then curing the uncured preform to form the inner fibrous reinforcement layer adjacent to the outer metal layer.

19. The method as recited in claim 18, wherein the expanding of the uncured preform includes internally pressurizing the uncured preform.

20. The method as recited in claim 18, wherein the curing of the uncured preform includes heating the uncured perform at a predetermined temperature.

21. The method as recited in claim 20, including heating the uncured preform in unison with internally pressurizing the uncured preform.

22. The method as recited in claim 18, including, prior to expanding the uncured preform, applying an adhesive to the uncured preform to form a bonding layer.

23. The method as recited in claim 18, wherein expanding the uncured preform includes pressurizing an inflatable bladder that is inside of the uncured perform.

24. The method as recited in claim 18, including, prior to expanding the uncured preform, providing a rib between the uncured preform and the outer metal layer, and then discharging air through a path adjacent to the rib during the expanding of the uncured preform.

25. An automated handling device, comprising:
at least one tool for handing a work piece;
a robotic machine for moving the at least one tool; and
at least one support arm connected between the at least one tool and the robotic machine, the at least one support arm including an elongated tubular body having an outer metal layer and an inner fibrous reinforcement layer adjacent to the outer metal layer.

26. The automated handling device as recited in claim 25, wherein the at least one tool is selected from a group consisting of powered clamps, suction cups, and powered grippers.

27. The automated handling device as recited in claim 25, further comprising a tool clamp secured on the at least one support arm that supports the at least one tool.

28. The automated handling device as recited in claim 27, wherein the tool clamp is in direct contact with an outer surface of the outer metal layer.
